(19) United States
(12) Patent Application Publication
(10) Pub. No.: US 2026/0056805 A1
(43) Pub. Date: Feb. 26, 2026

(54) TECHNOLOGIES FOR DEVICE CLUSTER AND NODE TRANSFER IN UBIQUITOUS COMPUTING

(71) Applicant: Apple Inc., Cupertino, CA (US)

(72) Inventors: Ralf Rossbach, Munich (DE); Mona Agnel, Guildford Surrey (GB); Sudeep Manithara Vamanan, Nuremberg (DE); Walter Featherstone, Cirencester Gloucestershire (GB)

(73) Assignee: Apple Inc., Cupertino, CA (US)

(21) Appl. No.: 19/287,791

(22) Filed: Jul. 31, 2025

Related U.S. Application Data
(60) Provisional application No. 63/685,218, filed on Aug. 20, 2024.

(51) Int. Cl. G06F 9/50; G06F 9/48

(52) U.S. Cl. CPC G06F 9/5083; G06F 9/4881

(57) ABSTRACT

The present application relates to devices and components including apparatus, systems, and methods for ubiquitous computing.

### CROSS-REFERENCE TO RELATED APPLICATION

This application claims priority to U.S. Provisional Ser. No. 63/685,218, filed Aug. 20, 2024, which is hereby incorporated by reference in its entirety.

### TECHNICAL FIELD

This application relates generally to communication networks and, in particular, to technologies for ubiquitous computing in wireless networks.

### BACKGROUND

Third Generation Partnership Project (3GPP) Technical Specifications (TSs) define standards for wireless networks. These TSs describe aspects related to signaling traffic through systems that incorporate wireless networks.

### BRIEF DESCRIPTION OF THE DRAWINGS

FIG. 1 illustrates a network environment in accordance with some embodiments.

FIG. 2 illustrates architecture approaches in accordance with some embodiments.

FIG. 3 illustrates another network environment in accordance with some embodiments.

FIG. 4 illustrates another network environment in accordance with some embodiments.

FIG. 5 illustrates another network environment in accordance with some embodiments.

FIG. 6 illustrates another network environment in accordance with some embodiments.

FIG. 7 illustrates another network environment in accordance with some embodiments.

FIG. 8 illustrates another network environment in accordance with some embodiments.

FIG. 9 illustrates an operational flow/algorithmic structure in accordance with some embodiments.

FIG. 10 illustrates another operational flow/algorithmic structure in accordance with some embodiments.

FIG. 11 illustrates another operational flow/algorithmic structure in accordance with some embodiments.

FIG. 12 illustrates a device in accordance with some embodiments.

FIG. 13 illustrates a network device in accordance with some embodiments.

### DETAILED DESCRIPTION

The following detailed description refers to the accompanying drawings. The same reference numbers may be used in different drawings to identify the same or similar elements. In the following description, for purposes of explanation and not limitation, specific details are set forth such as particular structures, architectures, interfaces, and techniques in order to provide a thorough understanding of the various aspects of various embodiments. However, it will be apparent to those skilled in the art having the benefit of the present disclosure that the various aspects of the various embodiments may be practiced in other examples that depart from these specific details. In certain instances, descriptions of well-known devices, circuits, and methods are omitted so as not to obscure the description of the various embodiments with unnecessary detail. For the purposes of the present document, the phrases “A/B” and “A or B” mean (A), (B), or (A and B); and the phrase “based on A” means “based at least in part on A,” for example, it could be “based solely on A” or it could be “based in part on A.”

The following is a glossary of terms that may be used in this disclosure.

The term “circuitry” as used herein refers to, is part of, or includes hardware components that are configured to provide the described functionality. The hardware components may include an electronic circuit, a logic circuit, a processor (shared, dedicated, or group) or memory (shared, dedicated, or group), an application specific integrated circuit (ASIC), a field-programmable device (FPD) (for example, a field-programmable gate array (FPGA), a programmable logic device (PLD), a complex PLD (CPLD), a high-capacity PLD (HCPLD), a structured ASIC, or a programmable system-on-a-chip (SoC)), or a digital signal processor (DSP). In some embodiments, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry.

The term “processor circuitry” as used herein refers to, is part of, or includes circuitry capable of sequentially and automatically carrying out a sequence of arithmetic or logical operations, or recording, storing, or transferring digital data. The term “processor circuitry” may refer an application processor, baseband processor, a central processing unit (CPU), a graphics processing unit, a single-core processor, a dual-core processor, a triple-core processor, a quad-core processor, or any other device capable of executing or otherwise operating computer-executable instructions, such as program code, software modules, or functional processes.

The term “interface circuitry” as used herein refers to, is part of, or includes circuitry that enables the exchange of information between two or more components or devices. The term “interface circuitry” may refer to one or more hardware interfaces, for example, buses, I/O interfaces, peripheral component interfaces, and network interface cards.

The term “user equipment” or “UE” as used herein refers to a device with radio communication capabilities that may allow a user to access network resources in a communications network. The term “user equipment” or “UE” may be considered synonymous to, and may be referred to as, client, mobile, mobile device, mobile terminal, user terminal, mobile unit, mobile station, mobile user, subscriber, user, remote station, access agent, user agent, receiver, radio equipment, reconfigurable radio equipment, or reconfigurable mobile device. Furthermore, the term “user equipment” or “UE” may include any type of wireless/wired device or any computing device including a wireless communications interface.

The term “computer system” as used herein refers to any type interconnected electronic devices, computer devices, or components thereof. Additionally, the term “computer system” or “system” may refer to various components of a computer that are communicatively coupled with one another. Furthermore, the term “computer system” or “system” may refer to multiple computer devices or multiple computing systems that are communicatively coupled with one another and configured to share computing or networking resources.

The term “resource” as used herein refers to a physical or virtual device, a physical or virtual component or asset within a computing or network environment, or a physical or virtual component within, accessible by, or available to a device or component. Resources could include, but are not limited to, memory space/usage, processor/CPU time, processor/CPU usage, processor and accelerator loads, hardware time or usage, electrical power, input/output operations, ports or network sockets, channel/link allocations, throughput, or workload units. A “hardware resource” may refer to compute, storage, or networking resources provided by physical hardware elements. A “virtualized resource” may refer to compute, storage, or networking resources provided by virtualization infrastructure to an application, device, or system. The term “communication resource” may refer to resources that are accessible by, or available to, computer devices/systems for transferring information over a channel of a communication network. For example, communication resources may include, but are not limited to, time/frequency resources, code resources, modulation resources, etc. The term “system resources” may refer to any kind of shared entities to provide services, and may include computing or network resources. System resources may be considered as a set of coherent functions, network data objects or services, accessible through a server where such system resources reside on a single host or multiple hosts and are clearly identifiable.

The term “channel” as used herein refers to any transmission medium, either tangible or intangible, which is used to communicate data or a data stream. The term “channel” may be synonymous with or equivalent to “communications channel,” “data communications channel,” “transmission channel,” “data transmission channel,” “access channel,” “data access channel,” “link,” “data link,” “carrier,” “radio-frequency carrier,” or any other like term denoting a pathway or medium through which data is communicated.

Additionally, the term “link” as used herein refers to a connection between two devices for the purpose of transmitting and receiving information.

The terms “instantiate,” “instantiation,” and the like as used herein refers to the creation of an instance. An “instance” also refers to a concrete occurrence of an object, which may occur, for example, during execution of program code.

The term “connected” may mean that two or more elements, at a common communication protocol layer, have an established signaling relationship with one another over a communication channel, link, interface, or reference point.

The term “network element” as used herein refers to physical or virtualized equipment or infrastructure used to provide wired or wireless communication network services. The term “network element” may be considered synonymous to or referred to as a networked computer, networking hardware, network equipment, network node, or a virtualized network function.

The term “information element” refers to a structural element containing one or more fields. The term “field” refers to individual contents of an information element, or a data element that contains content. An information element may include one or more additional information elements.

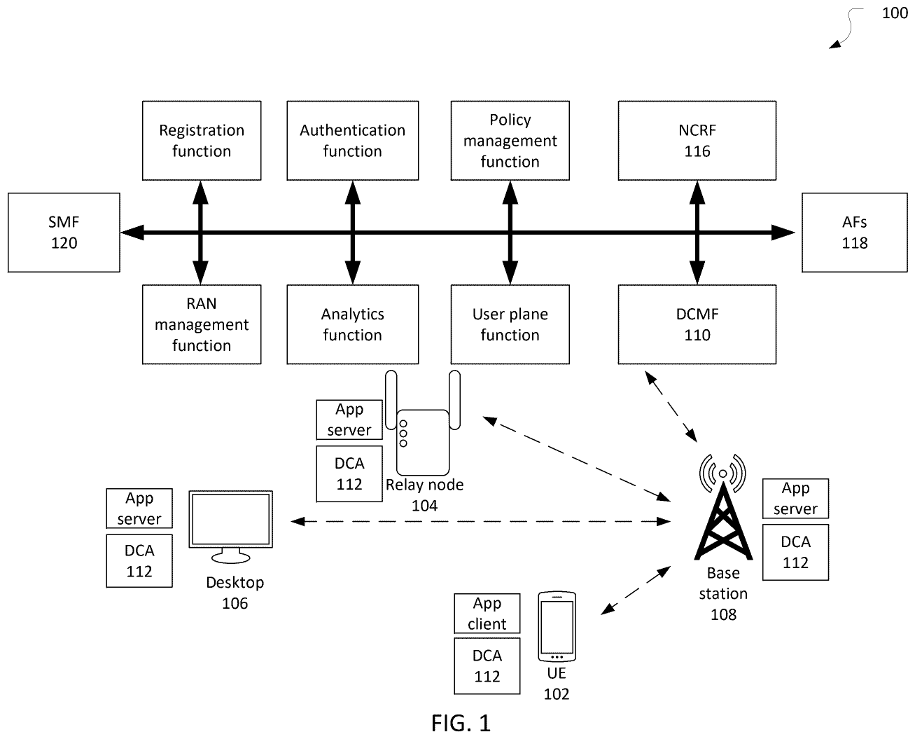

FIG. 1 illustrates a network environment 100 in accordance with some embodiments. The network environment 100 may include a user equipment (UE) 102, relay node 104, and desktop 106 communicatively coupled with a base station 108 of a radio access network (RAN). The UE 102, relay node 104, and desktop 106 may communicate with the base station 108 over air interfaces compatible with 3GPP TSs such as those that define a Sixth Generation (6G) system or a later system.

The network environment 100 may further include a core network coupled to the base station 108 via a fiber optic or wireless backhaul. The core network may provide various network functions for the devices of the network environment.

The network environment 100 may represent a 3GPP Core Network Centric Approach with an integrated compute and network fabric that provides a distributed intelligence that collect and analyze information on communication and computation resources in a mobile wireless network, discovers optimum resource/path (for example, a communication path to a computing resource) to offload computing tasks while preserving user privacy and help in executing offload

New network functions may include a Distributed Computing Management Function (DCMF) 110, distributed computing agents (DCAs) 112, and networked compute repository function (NCRF) 116.

The DCMF 110 may be a Network Function responsible for onboarding and provisioning network nodes with computing resources and network nodes with computing needs. The DCMF 110 may also be responsible for discovery of optimal compute resource and communication paths within the framework of trust and privacy requirements from application providers and users. The DCMF 110 may interact with Application Functions (AFs) 118 (direct or through Network Exposure framework), Session Management Function (SMF) 120, and DCAs 112. The UE 102 may also be considered a network node in this context.

The DCA 112 is an entity that is embedded in the network nodes and provides/requests computing resources. The DCA 112 has a server side and client side instantiation. The DCA 112 takes care of communication with the DCMF 110.

The NCRF 116 may provide some repository functions similar to a 5G Network Repository Function (NRF). The NCRF 116 may also be responsible for registering network nodes with computing resources (also 3rd party), and aiding their onboarding and discovery.

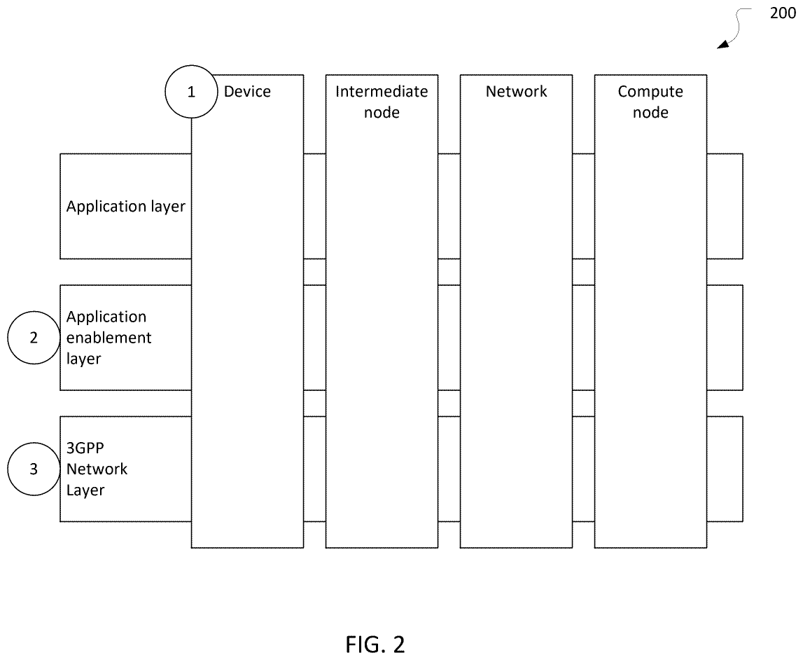

FIG. 2 illustrates architecture approaches 200 in accordance with some embodiments.

A first approach may be a device-centric approach that may be an extension or re-use of proximity services (ProSe) discovery/device-to-device (D2D) communications. An autonomous sub-network may use a local controller acting as a base station+device or cluster head. Thus, a local network may be maintained without a core network (CN). The compute aspects may be considered ‘application layer.’ Local devices may support local versions of Application Enablement/3GPP network layer functions.

A second approach may be an application enablement layer, which may be independent from a network. For example, the solution may be deployed separately from an operator network. A company may deploy related servers/functions that may be used for devices associated with that company. In some instances, the compute NFs of FIG. 1 may be understood as deployed through an application enablement or application-centric approach.

A third approach may be a 3GPP network layer approach. In this approach, functions and entities may be controlled by an operator. Key functions may reside in an operator's CN.

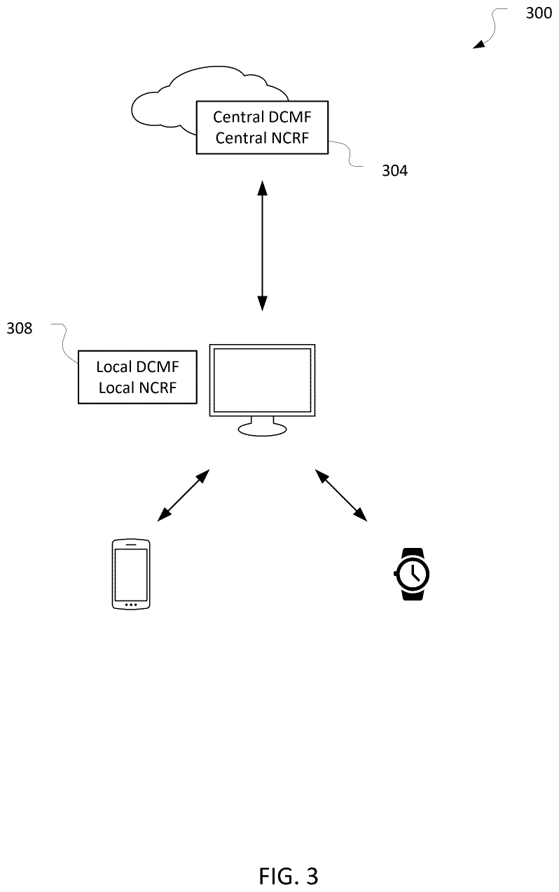

FIG. 3 illustrates another network environment in accordance with some embodiments.

As opposed to 5G where functions and services for computing are mostly defined as services ‘over the top’ or provided behind a 3GPP ‘border’ gateway such as a User Plane Function (UPF), compute functions of 6G may become a central or integral part of the 3GPP network itself. This may benefit from an architecture and respective network elements that form part of the 3GPP network.

Embodiments of this disclosure provide a system architecture and basic framework for ubiquitous computing from a device-centric perspective. This may be done by adding components and interactions between distributed computing network functions.

Proposed aspects are centered around the idea that a compute NF such as a DCMF or NCRF can be in a server of the CN (referred to as central DCMF/central NCRF 304) or hosted at a local device instance (referred to as local DCMF/local NCRF 308), for example on a powerful device. While DCMF-DCA procedures are considered agnostic to communication/connectivity layer, the compute functions are expected to form a separate functional layer that is part of the 6G network itself.

Embodiments of the present disclosure address how: UEs can form clusters of compute nodes, and the basic framework and structure for such clusters; how nodes in a cluster work collaboratively on a computation task, by enabling task scaling over multiple devices; and how one device/node can be promoted to a cluster head (or control/master node) while other devices act as processing/worker nodes.

Apart from single node operation, compute nodes may be organized to operate as multiple distributed nodes in a compute cluster. A compute cluster works jointly on a workload by distributing compute tasks over multiple nodes. A compute cluster may include control (master) and processing (worker) nodes. There can be more than one control node in a cluster. The compute nodes in a cluster may belong to the same user (prime use case) or to different users.

The DCA is typically located on the control node. If a device can only act as processing node it would need a DCA as well. So both control and processing nodes may host a DCA. The DCA functions provided by the control node may be wider than the DCA functions provided by a processing node. A control node hosts the compute control functions for the whole cluster and optionally local data processing functions. In such a setup, there would be two types of DCAs, a primary DCA and a secondary DCA. Alternatively, the two types of DCA could be organized as two separate components (whereby only the primary DCA is called DCA, and the secondary DCA is called something else—but this depends on the protocol model as discussed elsewhere herein).

A compute cluster can be formed: by the DCMF 110, in order to increase (or reach) the compute power required for larger workloads; by a single user, in order to enable offloading and efficient load distribution between his/her own devices (the user may further reconfigure the cluster according to his/her preferences, such that compute nodes may be enabled or disabled, node type changed, etc.); or as an arrangement (defined or pre-configured) depending on device type(s), compute framework (application layer) and software environment, hardware requirements, or based on user preferences. Protocols used for communication between devices (for example, DCAs and nodes) further depend on the capabilities of the devices, whether sidelink or relay is supported, etc.

A first aspect of the disclosure, referred to herein as Aspect 1, relate to primary and secondary DCAs.

A device hosting a control/master node may include primary DCA and control (master) node functions. The primary DCA may be a node management function acting as an interface to handle external communication with other compute nodes and the DCMF. The DCA also provides a set of application programming interfaces (APIs) and a stack interface.

Control (master) node functions may be implemented as separate functions or could be part of the DCA. The control node functions may include one or more of the following functions.

Job Control Function (JCF) to administer probes and measurements, supervise node operation, control alarm handling, and perform resource monitoring for jobs running on the nodes.

Scheduler Function (SF) to allocate workloads for execution on a node, including assignment of (related) tasks for execution, according to a scheduling algorithm. The scheduling algorithm can be controlled/configured by the Job Controller and/or the DCA/DCMF.

State and Storage Manager (SSM) to store the internal state of the compute node(s) in the cluster fora workload, for example. The SSM may act as distributed, consistent data store for configuration, service discovery, and scheduler coordination of the distributed nodes in a cluster. Multiple nodes may share the same SSM as a shared state, including, for example, multiple control nodes.

In some embodiments, the control node functions may optionally include a runtime environment (RE) or one or more worker units (WUs) in case a workload is configured to run on the control node itself. In some instances, this may make isolation between workloads harder to achieve.

Examples of a device hosting a control node may include a laptop/desktop computer, a UE, a relay node, a fixed wireless access (FWA) device, a base station, etc.

A device hosting a processing/worker node may include a secondary DCA, which may include APIs and a communication interface, and processing (worker) node functions. The processing (worker) node functions, which may be implemented as separate functions or could be part of the DCA, may include an RE for execution of scheduled workloads and interacting with the operating system and actual (WUs). A WU may include, for example, one or multiple containers, a virtual machine, a portion of an application with one or multiple OS tasks, or any other form of image/code representation. A worker unit may represent the finest granularity of a workload that can be scheduled on a single node or in a cluster.

Examples of a processing node include, but are not limited to, a UE, a wearable, a computer, or any type of device (including a control node).

In some embodiments, protocol models for distributed compute communication (for example, DCA to DCMF/NCRF communication) may correspond to one of the following two options.

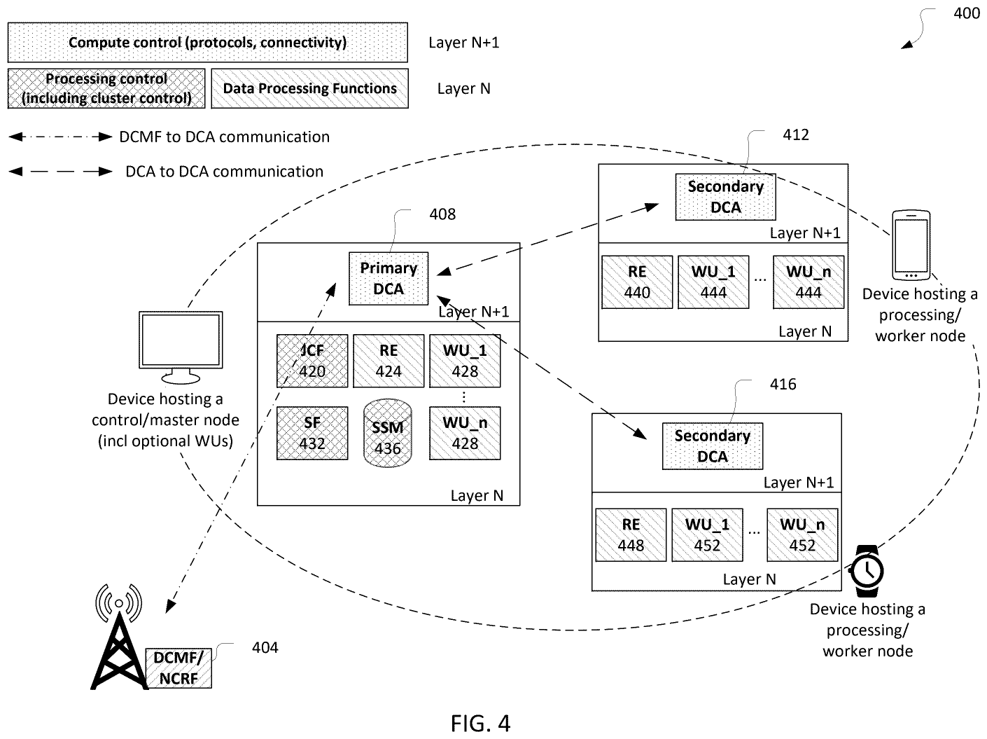

Option one may include indirect control as shown in the network environment 400 of FIG. 4 in accordance with some embodiments. DCMF/NCRF 404 communicates with primary DCA 408 (and vice versa). The primary DCA 408 communicates with secondary DCAs 412 and 416 (and vice versa). The primary DCA 408 may operate at layer N+1 and may be associated with a number of Layer N functions hosted by the same device. The Layer N functions may include, for example, JCF 420, an RE 424, a number of WUs 428, an SF 432, and an SSM 436. The secondary DCA 412 may operate at layer N+1 and may be associated with a number of Layer N functions hosted by the same device. The Layer N functions may include, for example, RE 440, and a number of WUs 444. The secondary DCA 416 may operate at layer N+1 and may be associated with a number of Layer N functions hosted by the same device. The Layer N functions may include, for example, RE 448, and a number of WUs 452.

Two sub-options of option one may be considered. In a first sub-option, the secondary DCAs 412 and 416 are not visible to the DCMF, for example, the primary DCA 408 appears as a single agent to the DCMF. However, to enable proper workload (offload task) matching at the DCMF, the primary DCA 408 can still indicate how many and what type of control/processing nodes it supports and what their capabilities are. In a second sub-option, the secondary DCAs 412 and 416 are visible to the DCMF through the primary DCA 408, that is, the primary DCA 408 acts as a relay. However, the composite distribution and scheduling of workloads in the cluster still happens via the primary DCA 408.

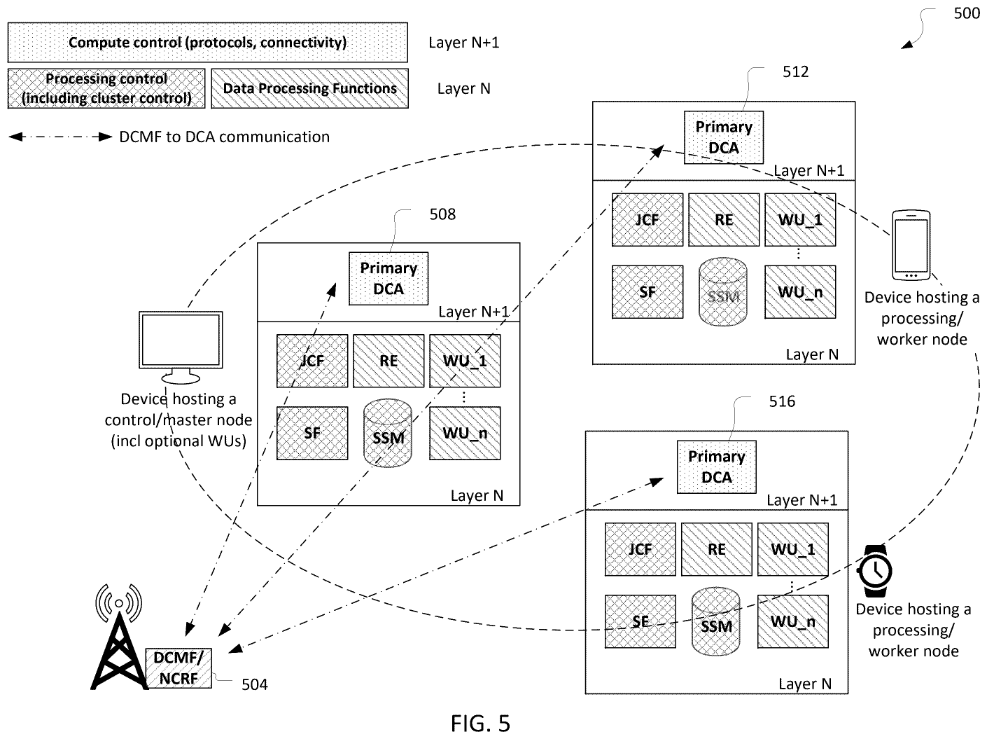

Option two may include direct control as shown in the network environment 500 of FIG. 5 in accordance with some embodiments. Network environment 500 includes primary DCAs 508, 512, and 516, each of which may include functions similar to those shown and described with respect to primary DCA 408. Every primary DCA 508, 512, and 516 communicates with DCMF/NCRF 504 via a direct link, thereby indicating whether it can act (in a fixed manner) or can be configured as (in a flexible manner): a control/master node, a processing/worker node, or both.

In embodiments that use direct communication, where all nodes are configured as a control/master node, the DCMF may handle the cluster control. However, workloads may still be distributed over multiples nodes as long as it is clear which node acts as a cluster head. Having multiple nodes with control/master capability in a cluster allows for the possibility to switch the cluster head from one node to another. This process can be controlled by the DCMF. Alternatively, nodes can also elect a cluster head autonomously, using a pre-programmed algorithm or an algorithm configured by the DCMF. See Aspect 5 of the disclosure.

A second aspect of the disclosure, referred to herein as Aspect 2, relates to topological resilience.

Topological resilience may be provided through wireless mesh networks. In this embodiment, every UE or base station with a DCA connected to a DCMF/NCRF hosts a mesh node. Any such node allows access from other DCAs in the community or group (or from a specific access level that can be defined), for example, via SL, another RAT, or non-3GPP access technologies. A mesh node is responsible for forwarding data traffic of other mesh nodes, and these mutual connections build a network. In this manner the local DCMF/NCRF, the next DCA, or the next cluster head (control/master node) can be available even if the direct link fails.

Alternatively or additionally, nodes in a device cluster may be administered and connected via a service mesh—as an optional part only. This option does not necessarily require dedicated protocol functions for cluster head election. The control plane of the service mesh can take care of administration and configuration of the service mesh.

A third aspect of the disclosure, referred to herein as Aspect 3, relates to protocol model for inter-node communication between control and processing nodes. This may be done in accordance with one or more of the following three options.

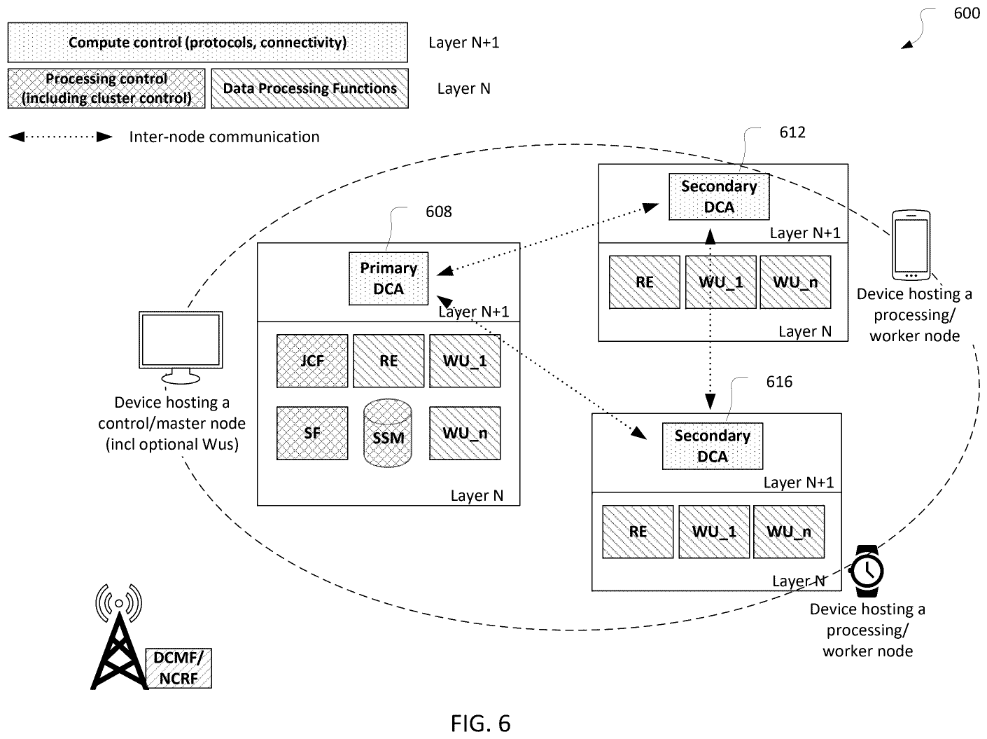

In a first option, inter-node messages are sent from DCA to DCA, where every DCA communicates with its underlying compute node functions. See network environment 600 of FIG. 6 in accordance with some embodiments. The network environment 600 may include primary DCA 608, secondary DCA 612, and secondary DCA 616, similar to network environment 500. However, in network environment 600, each DCA may be directly connected with one another. The DCA acts as a connectivity layer or gateway/proxy of the compute node, for example, piggybacking inter-node messages or creating separate messages on behalf of the compute nodes.

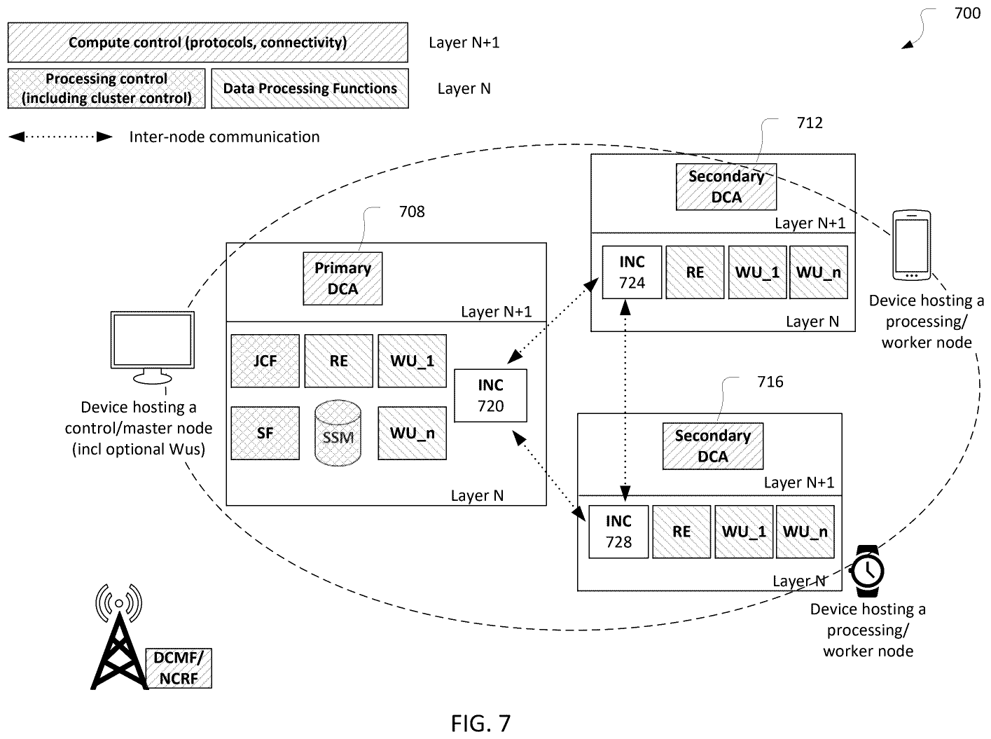

In a second option, the compute nodes have a separate sub-function or inter-node communication (INC) node that provides a connectivity layer or proxy/gateway for inter-node communication at node level. See network environment 700 of FIG. 7 in accordance with some embodiments. The network environment 700 may include primary DCA 708, secondary DCA 712, and secondary DCA 716, similar to network environment 500. However, in network environment 700, each device may include an inter-node communicator (INC) as a Layer N function, for example, INC 720, INC 724, and INC 728. The INCs will communicate with respective DCAs on the same device and will communicate with other INCs on other devices. Thus, the INCs will provide inter-node communication directly between the nodes at a protocol level different from the DCAs. This option allows communications between DCA—DCMF/NCRF or DCA—DCA to be run as separate protocols, independently (with less coupling) of the communication between compute nodes.

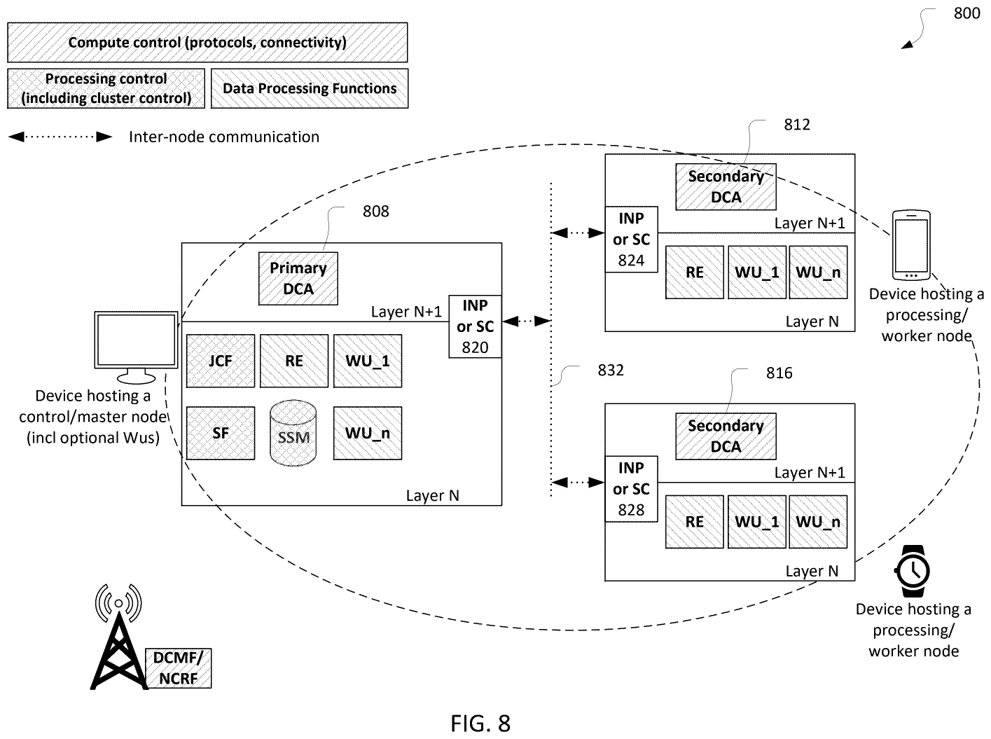

A third option may be similar to the second option but here, each node implements a inter-node communication proxy (INP) or Sidecar (SC) (with a protocol adaptation function), capable to communicate over a service-based-interface. See network environment 800 of FIG. 8 in accordance with some embodiments. The network environment 800 may include primary DCA 808, secondary DCA 812, and secondary DCA 816, similar to network environment 500. However, in network environment 800, each device may include an INP or SC, for example, INP or SC 820, INP or SC 824, and INP or SC 828. The INPs or SCs will communicate with respective DCAs on the same device and will communicate with other INPs or SCs on other devices through a service-based interface 832. This option allows the nodes in the cluster to operate as a service mesh. Using the service-based interface 832 may make it easier to adapt or transfer some of the APIs from CN service-based interface, which may sit on top of hypertext transfer protocol (HTTP). Thus, native cloud based computing principles may be used for communication within the cluster of nodes.

For topological resilience, devices can be inter-connected via a mesh network (for example, over sidelink (SL) or non-3GPP). In case of a direct link failure: devices retain connectivity to other nodes in the system via alternative links; protocol messages can be rerouted to its respective destination through the mesh; secondary DCAs can communicate with the base station on behalf of the primary DCA (acting as a SL relay). Alternatively, point-to-point (P2P) connections are possible as well (over SL, non-3GPP, or with the base station acting as a relay).

A fourth aspect of this disclosure, referred to herein as Aspect 4, relates to node switching and UE capabilities.

There may be situations where a primary DCA must be switched to a secondary DCA. For example, if a computer disappears the UE could take over the remaining devices in the cluster. The switch could be based on device capabilities, that is, a UE (or any device) may indicate whether it is capable to instantiate and run all the components needed for a control node, and it may further indicate whether or not it can also act as a DCMF/NCRF and/or a processing node. These functions can be organized as (separate) UE capabilities where the device can indicate whether it can perform one or more of the following roles: Local DCMF; Local NCRF; Hybrid DCMF/NCRF; Control node only; Processing node only; or Combined Control+Processing node.

A fifth aspect of this disclosure, referred to herein as Aspect 5, relates to cluster head selection and/or reassignment.

If the cluster head disappears or becomes unresponsive, one or more of the following options may be used to select a new cluster head.

In a first option, the DCMF assigns a new control node as a cluster head. This may be done by, for example, a DCA-DCMF protocol.

In a second option, before going out of service, the old cluster head transfers control to a new cluster head. This may follow a handshake with another device or a handshake with the DCMF.

In a third option, devices select (or elect) a new cluster head autonomously.

A choice between the above options may depend on the scenario as well as the overall configuration of the cluster, and whether direct or indirect control is used as described in Aspect 1, for example. The choice may be based on a general configuration or rule, which may encompass one or more of the following: pre-programmed into the device; configured by the device owners themselves; configured and allocated by the network; controlled by the network operator; or otherwise specified.

Autonomous cluster head (control/master) node selection/re-selection (for example, the third option discussed above) may be performed as follows.

Every node takes the parameters that describe its own compute resources and its ability to act as a control/master node and maps it to a “capability ID.” The mechanism is such that no two nodes can have the same capability ID. It can be a hash function. More generally, capability IDs can be sorted in a particular order according to a rule that is configurable (such that higher/lower values are associated with a weight). For example, higher numbered capability IDs identify a device as eligible to act as a cluster head.

In some embodiments, ranges of capability IDs may be defined. For example, range1 may be for processing/worker nodes and a (higher numbered) range2 may be for control/master nodes. Only IDs of range2 may participate in the election. Other orders are possible as well, based on a rule or starting with the lowest numbered IDs.

When a control node is no longer available, remaining nodes in the cluster select or elect a new cluster head based on a configured mapping rule defined and an election algorithm, both of which can be configured by the network through DCMF-DCA signalling (for example, as part of DCA registration) or may be pre-defined for the nodes a cluster Although it is only the control nodes that participate in the election, nodes not capable of acting as a control node (for example, a simple processing/worker node) may still send an announcement message to all other nodes in the cluster, to inform other nodes of the failure (the unresponsive control node ID can be a parameter). The first (eligible) control node receiving the announcement then initiates the election. Likewise any control node can initiate the election.

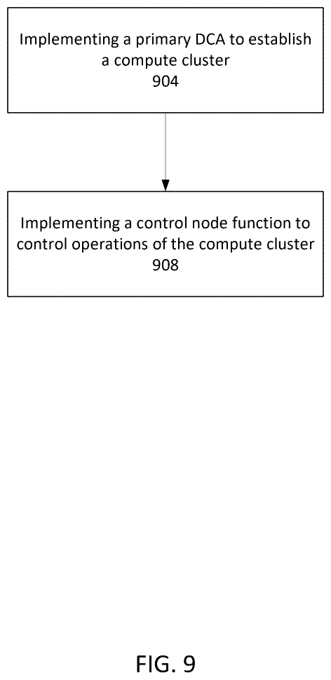

FIG. 9 illustrates an operation flow/algorithmic structure 900 in accordance with some embodiments. The operation flow/algorithmic structure 900 may be performed by, or implemented in, a device (for example, UE 102, relay node 104, desktop 106, or base station 108) or components therein such as, for example, processor circuitry 1204 or 1304.

The operation flow/algorithmic structure 900 may include, at 904, implementing a primary DCA to establish a compute cluster. The primary DCA may be used to communicate with a compute node of another device (for example, UE, relay node, desktop, base station, etc.) and a compute NF of a core network. The compute NF may be, for example, DCMF 110 or NCRF 116.

In some embodiments, the primary DCA may communicate with secondary DCAs located on other devices directly, through an INC (for example, INC 720), or through an INP or SC (for example, INP or SC 820). For example, the primary DCA may transmit/receive an inter-node message to/from another DCI directly. Additionally/alternatively, the primary DCA may transmit/receive an inter-node message to/from another DCI via an INC function. Additionally/alternatively, the primary DCA may transmit/receive an inter-node message to/from another DCI via an INP or SC using a service-based interface.

The operation flow/algorithmic structure 900 may further include, at 908, implementing a control node function to control operations of the compute cluster. The control node function may be a JCF (for example, JCF 420) to administer probes and measurements, supervise node operation, control alarm handling, perform resource monitoring for jobs running on computing nodes. The control node function may additionally/alternatively be an SF (for example, SF 432) to allocate workloads for execution on a node based on a scheduling algorithm. The control node function may additionally/alternatively be an SSM (for example, SF 436) to store an internal state of compute nodes in the compute cluster.

In some embodiments, the operation flow/algorithmic structure 900 may further include implementing an RE (for example, RE 424). The RE may interact with an operating system of a device hosting the RE for execution of scheduled workloads.

In some embodiments, the operation flow/algorithmic structure 900 may further include implementing a WU (for example, WU 428). The WU may process a workload scheduled as part of a distributed computing operation of the compute cluster.

In some embodiments, the operation flow/algorithmic structure 900 may further include hosting a mesh node to provide access to another DCA.

In some embodiments, the operation flow/algorithmic structure 900 may further include switching from implementing the primary DCA to implementing a secondary DCA. In these embodiments, another device in the compute cluster may take over the primary DCA.

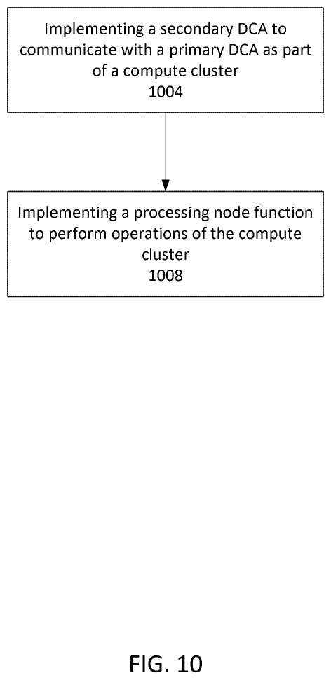

FIG. 10 illustrates an operation flow/algorithmic structure 1000 in accordance with some embodiments. The operation flow/algorithmic structure 1000 may be performed by, or implemented in, a device (for example, UE 102, relay node 104, desktop 106, or base station 108) or components therein such as, for example, processor circuitry 1204 or 1304.

The operation flow/algorithmic structure 1000 may include, at 1004, implementing a secondary DCA to communicate with a primary DCA as part of a compute cluster.

The operation flow/algorithmic structure 1000 may further include, at 1008, implementing a processing node function to perform operations of the compute cluster. The processing node function may be an RE (for example, RE 440 or RE 448) to interact with an operating system for execution of scheduled workloads. The processing node function may additionally/alternatively be a WU to process a workload scheduled as part of a distributed compute operation.

In some embodiments, the operation flow/algorithmic structure 1000 may further include switching from implementing the secondary DCA to implementing a primary DCA.

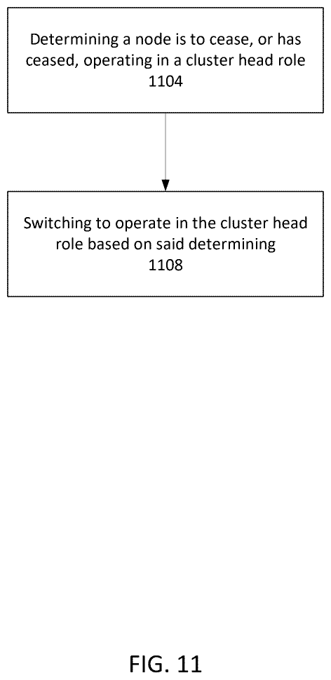

FIG. 11 illustrates an operation flow/algorithmic structure 1100 in accordance with some embodiments. The operation flow/algorithmic structure 1100 may be performed by, or implemented in, a device (for example, UE 102, relay node 104, desktop 106, or base station 108) or components therein such as, for example, processor circuitry 1204 or 1304.

The operation flow/algorithmic structure 1100 may include, at 1104, determining a node is to cease, or has ceased, operating in a cluster head role.

The operation flow/algorithmic structure 1000 may further include, at 1008, switching to the cluster head role after making the determination at 1104.

In some embodiments, the switching to the cluster head role may be based on receiving an assignment from a DCMF, performing a handshake operation with the node that previously operated in the cluster head role, or performing an autonomous cluster head reselection operation based on a capability ID. The capability ID may be based on compute resources or ability to act in the cluster head role.

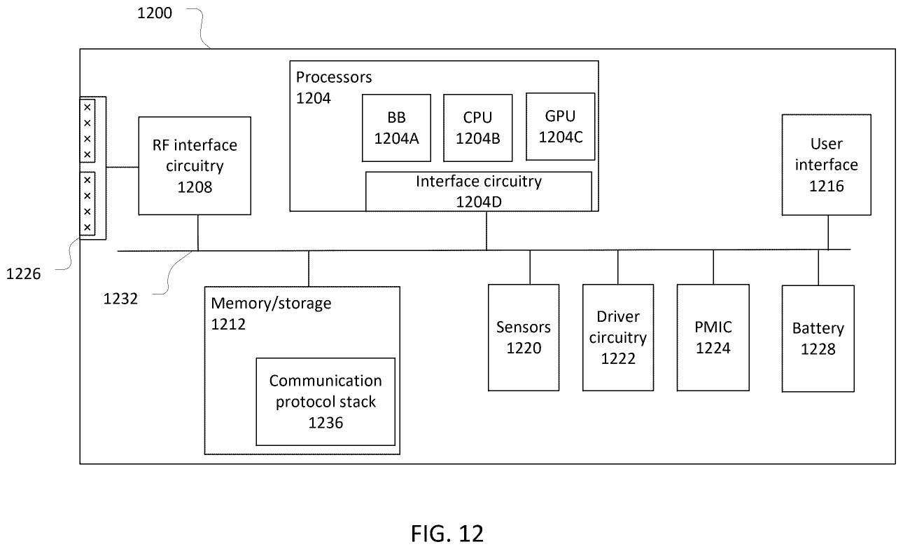

FIG. 12 illustrates a device 1200 in accordance with some embodiments. The device 1200 may be similar to and substantially interchangeable with any devices hosting nodes as discussed herein.

The device 1200 may be any mobile or non-mobile computing device, such as, for example, mobile phones, computers, tablets, industrial wireless sensors (for example, microphones, carbon dioxide sensors, pressure sensors, humidity sensors, thermometers, motion sensors, accelerometers, laser scanners, fluid level sensors, inventory sensors, electric voltage/current meters, or actuators), video surveillance/monitoring devices (for example, cameras or video cameras), wearable devices (for example, a smart watch), or Internet-of-things devices.

The device 1200 may include processors 1204, RF interface circuitry 1208, memory/storage 1212, user interface 1216, sensors 1220, driver circuitry 1222, power management integrated circuit (PMIC) 1224, antenna 1226, and battery 1228. The components of the device 1200 may be implemented as integrated circuits (ICs), portions thereof, discrete electronic devices, or other modules, logic, hardware, software, firmware, or a combination thereof. The block diagram of FIG. 12 is intended to show a high-level view of some of the components of the device 1200. However, some of the components shown may be omitted, additional components may be present, and different arrangement of the components shown may occur in other implementations.

The components of the device 1200 may be coupled with various other components over one or more interconnects 1232, which may represent any type of interface, input/output, bus (local, system, or expansion), transmission line, trace, or optical connection that allows various circuit components (on common or different chips or chipsets) to interact with one another.

The processors 1204 may include processor circuitry such as, for example, baseband processor circuitry (BB) 1204A, central processor unit circuitry (CPU) 1204B, and graphics processor unit circuitry (GPU) 1204C. The processors 1204 may include any type of circuitry or processor circuitry that executes or otherwise operates computer-executable instructions, such as program code, software modules, or functional processes from memory/storage 1212 to cause the device 1200 to perform ubiquitous computing operations as described herein. The processors 1204 may also include interface circuitry 1204D to communicatively couple the processor circuitry with one or more other components of the device 1200.

In some embodiments, the baseband processor 1204A may access a communication protocol stack 1236 in the memory/storage 1212 to communicate over a 3GPP compatible network. In general, the baseband processor 1204A may access the communication protocol stack 1236 to: perform user plane functions at a PHY layer, MAC layer, RLC layer, PDCP layer, SDAP layer, and PDU layer; and perform control plane functions at a PHY layer, MAC layer, RLC layer, PDCP layer, RRC layer, and a NAS layer. In some embodiments, the PHY layer operations may additionally/alternatively be performed by the components of the RF interface circuitry 1208.

The baseband processor 1204A may generate or process baseband signals or waveforms that carry information in 3GPP-compatible networks. In some embodiments, the waveforms for NR may be based on cyclic prefix OFDM (CP-OFDM) in the uplink or downlink, and discrete Fourier transform spread OFDM (DFT-S-OFDM) in the uplink.

The memory/storage 1212 may include one or more non-transitory, computer-readable media that includes instructions (for example, communication protocol stack 1236) that may be executed by one or more of the processors 1204 to cause the device 1200 to perform ubiquitous computing operations as described herein.

The memory/storage 1212 includes any type of volatile or non-volatile memory that may be distributed throughout the device 1200. In some embodiments, some of the memory/storage 1212 may be located on the processors 1204 themselves (for example, memory/storage 1212 may be part of a chipset that corresponds to the baseband processor 1204A), while other memory/storage 1212 is external to the processors 1204 but accessible thereto via a memory interface. The memory/storage 1212 may include any suitable volatile or non-volatile memory such as, but not limited to, dynamic random access memory (DRAM), static random access memory (SRAM), erasable programmable read only memory (EPROM), electrically erasable programmable read only memory (EEPROM), Flash memory, solid-state memory, or any other type of memory device technology.

The RF interface circuitry 1208 may include transceiver circuitry and a radio frequency front module (RFEM) that allows the device 1200 to communicate with other devices over a radio access network. The RF interface circuitry 1208 may include various elements arranged in transmit or receive paths. These elements may include, for example, switches, mixers, amplifiers, filters, synthesizer circuitry, and control circuitry.

In the receive path, the RFEM may receive a radiated signal from an air interface via antenna 1226 and proceed to filter and amplify (with a low-noise amplifier) the signal. The signal may be provided to a receiver of the transceiver that down-converts the RF signal into a baseband signal that is provided to the baseband processor of the processors 1204.

In the transmit path, the transmitter of the transceiver up-converts the baseband signal received from the baseband processor and provides the RF signal to the RFEM. The RFEM may amplify the RF signal through a power amplifier prior to the signal being radiated across the air interface via the antenna 1226.

In various embodiments, the RF interface circuitry 1208 may be configured to transmit/receive signals in a manner compatible with NR access technologies.

The antenna 1226 may include antenna elements to convert electrical signals into radio waves to travel through the air and to convert received radio waves into electrical signals. The antenna elements may be arranged into one or more antenna panels. The antenna 1226 may have antenna panels that are omnidirectional, directional, or a combination thereof to enable beamforming and multiple input, multiple output communications. The antenna 1226 may include microstrip antennas, printed antennas fabricated on the surface of one or more printed circuit boards, patch antennas, or phased array antennas. The antenna 1226 may have one or more panels designed for specific frequency bands including bands in FR1 or FR2.

The user interface 1216 includes various input/output (I/O) devices designed to enable user interaction with the device 1200. The user interface 1216 includes input device circuitry and output device circuitry. Input device circuitry includes any physical or virtual means for accepting an input including, inter alia, one or more physical or virtual buttons (for example, a reset button), a physical keyboard, keypad, mouse, touchpad, touchscreen, microphones, scanner, headset, or the like. The output device circuitry includes any physical or virtual means for showing information or otherwise conveying information, such as sensor readings, actuator position(s), or other like information. Output device circuitry may include any number or combinations of audio or visual display, including, inter alia, one or more simple visual outputs/indicators (for example, binary status indicators such as light emitting diodes (LEDs) and multi-character visual outputs, or more complex outputs such as display devices or touchscreens (for example, liquid crystal displays (LCDs), LED displays, quantum dot displays, and projectors), with the output of characters, graphics, multimedia objects, and the like being generated or produced from the operation of the device 1200.

The sensors 1220 may include devices, modules, or subsystems whose purpose is to detect events or changes in their environment and send the information (sensor data) about the detected events to some other device, module, or subsystem. Examples of such sensors include inertia measurement units comprising accelerometers, gyroscopes, or magnetometers; microelectromechanical systems or nanoelectromechanical systems comprising 3-axis accelerometers, 3-axis gyroscopes, or magnetometers; level sensors; flow sensors; temperature sensors (for example, thermistors); pressure sensors; barometric pressure sensors; gravimeters; altimeters; image capture devices (for example, cameras or lensless apertures); light detection and ranging sensors; proximity sensors (for example, infrared radiation detector and the like); depth sensors; ambient light sensors; ultrasonic transceivers; and microphones or other like audio capture devices.

The driver circuitry 1222 may include software and hardware elements that operate to control particular devices that are embedded in the device 1200, attached to the device 1200, or otherwise communicatively coupled with the device 1200. The driver circuitry 1222 may include individual drivers allowing other components to interact with or control various input/output (I/O) devices that may be present within, or connected to, the device 1200. For example, driver circuitry 1222 may include a display driver to control and allow access to a display device, a touchscreen driver to control and allow access to a touchscreen interface, sensor drivers to obtain sensor readings of sensors 1220 and control and allow access to sensors 1220, drivers to obtain actuator positions of electro-mechanic components or control and allow access to the electro-mechanic components, a camera driver to control and allow access to an embedded image capture device, audio drivers to control and allow access to one or more audio devices.

The PMIC 1224 may manage power provided to various components of the device 1200. In particular, with respect to the processors 1204, the PMIC 1224 may control power-source selection, voltage scaling, battery charging, or DC-to-DC conversion.

A battery 1228 may power the device 1200, although in some examples the device 1200 may be mounted deployed in a fixed location and may have a power supply coupled to an electrical grid. The battery 1228 may be a lithium ion battery, a metal-air battery, such as a zinc-air battery, an aluminum-air battery, a lithium-air battery, and the like. In some implementations, such as in vehicle-based applications, the battery 1228 may be a typical lead-acid automotive battery.

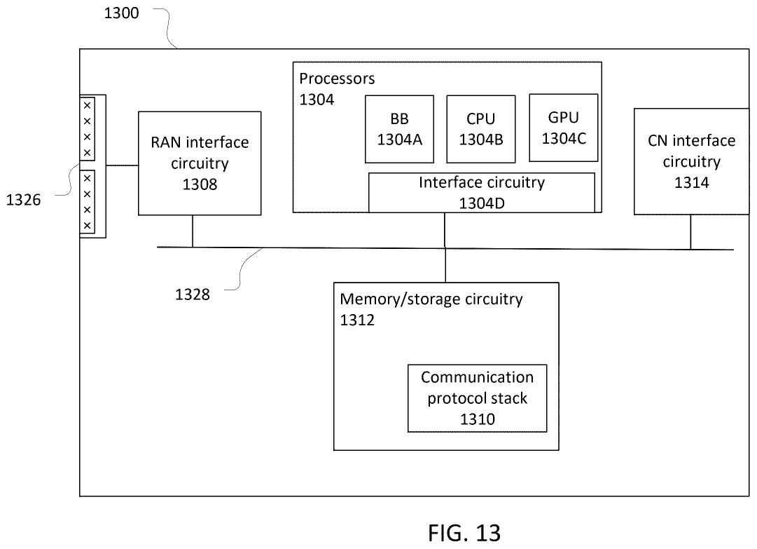

FIG. 13 illustrates a network device 1300 in accordance with some embodiments. The network device 1300 may be similar to, and substantially interchangeable with, the base station or a node implementing an NF such as, for example, a NCRF/DCMF.

The network device 1300 may include processors 1304, RF interface circuitry 1308 (if implemented as a base station), CN interface circuitry 1314, memory/storage circuitry 1312, and antenna structure 1326.

The components of the network device 1300 may be coupled with various other components over one or more interconnects 1328.

The processors 1304, RF interface circuitry 1308, memory/storage circuitry 1312 (including communication protocol stack 1310), antenna structure 1326, and interconnects 1328 may be similar to like-named elements shown and described with respect to FIG. 12.

The processors 1304 may include processor circuitry such as, for example, baseband processor circuitry (BB) 1304A, central processor unit circuitry (CPU) 1304B, and graphics processor unit circuitry (GPU) 1304C. The processors 1304 may include any type of circuitry or processor circuitry that executes or otherwise operates computer-executable instructions, such as program code, software modules, or functional processes from memory/storage circuitry 1312 to cause the network device 1300 to configure a device as described herein. The processors 1304 may also include interface circuitry 1304D to communicatively couple the processor circuitry with one or more other components of the network device 1300.

The CN interface circuitry 1314 may provide connectivity to a core network, for example, a Sixth Generation Core network (6GC) using a 6GC-compatible network interface protocol such as carrier Ethernet protocols, or some other suitable protocol.

Network connectivity may be provided to/from the network device 1300 via a fiber optic or wireless backhaul. The CN interface circuitry 1314 may include one or more dedicated processors or FPGAs to communicate using one or more of the aforementioned protocols. In some implementations, the CN interface circuitry 1314 may include multiple controllers to provide connectivity to other networks using the same or different protocols.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

For one or more embodiments, at least one of the components set forth in one or more of the preceding figures may be configured to perform one or more operations, techniques, processes, or methods as set forth in the example section below. For example, the baseband circuitry as described above in connection with one or more of the preceding figures may be configured to operate in accordance with one or more of the examples set forth below. For another example, circuitry associated with a UE, base station, or network element as described above in connection with one or more of the preceding figures may be configured to operate in accordance with one or more of the examples set forth below in the example section.

### EXAMPLES

In the following sections, further exemplary embodiments are provided.
Example 1 includes a method comprising: implementing a primary DCA to communicate with a compute node and a compute NF (for example, a DCMF or an NCRF); and implementing a control node function to control operations of the compute cluster, the control node function to include a JCF, an SF, or an SSM.
Example 2 includes the method of example 1 or some other example herein, wherein the control node function includes a JCF to administer probes and measurements, supervise node operation, control alarm handling, or perform resource monitoring for jobs running on compute nodes in the compute cluster.
Example 3 includes the method of example 1 or some other example herein, wherein the control node function includes an SF to allocate workloads for execution on a node based on a scheduling algorithm.
Example 4 includes the method of example 1 or some other example herein, wherein the control node function includes an SSM to store an internal state of compute nodes in the compute cluster.
Example 5 includes the method of example 1 or some other example herein, further comprising: implementing a runtime environment for execution of scheduled workloads in interacting with an operating system.
Example 6 includes the method of example 1 or some other example herein, further comprising: implementing a worker unit to process a workload scheduled as part of a distributed computing operation of the compute cluster.
Example 7 includes the method of example 1 or some other example herein, further comprising: hosting a mesh node to provide access to another DCA.
Example 8 includes the method of example 1 or some other example herein, further comprising: transmitting, directly by the primary DCA, an inter-node message to another DCA; or receiving, directly by the primary DCA, an inter-node message from another DCA.
Example 9 includes the method of example 1 or some other example herein, further comprising: transmitting, via an inter-node communication function, an inter-node message to another inter-node communication function; or receiving, via an inter-node communication function, an inter-node message from another inter-node communication function.
Example 10 includes the method of example 1 or some other example herein, further comprising: transmitting, via a service-based interface, an inter-node message to another node; or receiving, via a service-based interface, an inter-node message from another node.
Example 11 includes the method of example 1 or some other example herein, further comprising: switching from implementing the primary DCA to implementing a secondary DCA.
Example 12 includes a method comprising: implementing a secondary DCA to communicate with a primary DCA as part of a compute cluster; and implementing a processing node function to perform operations of the compute cluster, the processing node function to include a runtime environment (RE) or worker unit (WU).
Example 13 includes the method of example 12 or some other example herein, wherein the one or more processing node functions includes a runtime environment for execution of scheduled workloads in interacting with an operating system.
Example 14 includes the method of example 12 or some other example herein, wherein the one or more processing node functions includes a worker unit process a workload scheduled as part of a distributed computing operation.
Example 15 includes the method of example 12 or some other example herein, further comprising: switching from implementing the secondary DCA to implementing a primary DCA.
Example 16 includes a method comprising: determining a node is to cease, or has ceased, operating in a cluster head role; and switching to the cluster head role based on said determining.
Example 17 includes the method of example 16 or some other example herein, further comprising: receiving an assignment from a DCMF; and switching to the cluster head role based on receiving the assignment.
Example 18 includes the method of example 16 or some other example herein, further comprising: performing a handshake operation with the node operating in the cluster head role; and switching to the cluster head role based on performing the handshake operation.
Example 19 includes the method of example 16 or some other example herein, further comprising: performing an autonomous cluster head reselection operation based on a capability ID; and switching to the cluster head role based on performing the autonomous cluster head reselection operation.
Example 20 includes the method of example 19 or some other example herein, wherein the capability ID is based on compute resources or ability to act in the cluster head role.

Another example may include an apparatus comprising means to perform one or more elements of a method described in or related to any of examples 1-20, or any other method or process described herein.

Another example may include one or more non-transitory computer-readable media comprising instructions to cause an electronic device, upon execution of the instructions by one or more processors of the electronic device, to perform one or more elements of a method described in or related to any of examples 1-20, or any other method or process described herein.

Another example may include an apparatus comprising logic, modules, or circuitry to perform one or more elements of a method described in or related to any of examples 1-20, or any other method or process described herein.

Another example may include a method, technique, or process as described in or related to any of examples 1-20, or portions or parts thereof.

Another example may include an apparatus comprising: one or more processors and one or more computer-readable media comprising instructions that, when executed by the one or more processors, cause the one or more processors to perform the method, techniques, or process as described in or related to any of examples 1-20, or portions thereof.

Another example may include a signal as described in or related to any of examples 1-20, or portions or parts thereof.

Another example may include a datagram, information element, packet, frame, segment, PDU, or message as described in or related to any of examples 1-20, or portions or parts thereof, or otherwise described in the present disclosure.

Another example may include a signal encoded with data as described in or related to any of examples 1-20, or portions or parts thereof, or otherwise described in the present disclosure.

Another example may include a signal encoded with a datagram, IE, packet, frame, segment, PDU, or message as described in or related to any of examples 1-20, or portions or parts thereof, or otherwise described in the present disclosure.

Another example may include an electromagnetic signal carrying computer-readable instructions, wherein execution of the computer-readable instructions by one or more processors is to cause the one or more processors to perform the method, techniques, or process as described in or related to any of examples 1-20, or portions thereof.

Another example may include a computer program comprising instructions, wherein execution of the program by a processing element is to cause the processing element to carry out the method, techniques, or process as described in or related to any of examples 1-20, or portions thereof.

Another example may include a signal in a wireless network as shown and described herein.

Another example may include a method of communicating in a wireless network as shown and described herein.

Another example may include a system for providing wireless communication as shown and described herein.

Another example may include a device for providing wireless communication as shown and described herein.

Any of the above-described examples may be combined with any other example (or combination of examples), unless explicitly stated otherwise. The foregoing description of one or more implementations provides illustration and description, but is not intended to be exhaustive or to limit the scope of embodiments to the precise form disclosed. Modifications and variations are possible in light of the above teachings or may be acquired from practice of various embodiments.

Although the embodiments above have been described in considerable detail, numerous variations and modifications will become apparent to those skilled in the art once the above disclosure is fully appreciated. It is intended that the following claims be interpreted to embrace all such variations and modifications.

What is claimed is:

1. A method comprising:
implementing a primary distributed computing agent (DCA) to communicate with a compute node of a device and a distributed computing management function (DCMF) or networked compute repository function (NCRF) to establish a compute cluster; and
implementing a control node function to control operations of the compute cluster, the control node function to include a job control function (JCF), a scheduler function (SF), or a state and storage manager (SSM).

2. The method of claim 1, wherein the control node function comprises a JCF to administer probes and measurements, supervise node operation, control alarm handling, or perform resource monitoring for jobs running on compute nodes in the compute cluster.

3. The method of claim 1, wherein the control node function comprises an SF to allocate workloads for execution on a node based on a scheduling algorithm.

4. The method of claim 1, wherein the control node function comprises an SSM to store an internal state of compute nodes in the compute cluster.

5. The method of claim 1, further comprising:
implementing a runtime environment for execution of scheduled workloads in interacting with an operating system.

6. The method of claim 1, further comprising:
implementing a worker unit to process a workload scheduled as part of a distributed computing operation of the compute cluster.

7. The method of claim 1, further comprising:
hosting a mesh node to provide access to another DCA.

8. The method of claim 1, further comprising:
transmitting, directly by the primary DCA, an inter-node message to another DCA; or
receiving, directly by the primary DCA, an inter-node message from another DCA.

9. The method of claim 1, further comprising:
transmitting, via an inter-node communication function, an inter-node message to another inter-node communication function; or
receiving, via an inter-node communication function, an inter-node message from another inter-node communication function.

10. The method of claim 1, further comprising:
transmitting, via a service-based interface, an inter-node message to another node; or
receiving, via a service-based interface, an inter-node message from another node.

11. The method of claim 1, further comprising:
switching from implementing the primary DCA to implementing a secondary DCA.

12. A method comprising:
implementing a secondary distributed computing agent (DCA) to communicate with a primary DCA as part of a compute cluster; and
implementing a processing node function to perform operations of the compute cluster, the processing node function to include a runtime environment (RE) or worker unit (WU).

13. The method of claim 12, wherein the one or more processing node functions includes a runtime environment for execution of scheduled workloads in interacting with an operating system.

14. The method of claim 12, wherein the one or more processing node functions includes a worker unit process a workload scheduled as part of a distributed computing operation.

15. The method of claim 12, further comprising:
switching from implementing the secondary DCA to implementing a primary DCA.

16. A method comprising:
determining a node is to cease, or has ceased, operating in a cluster head role; and
switching to the cluster head role based on said determining.

17. The method of claim 16, further comprising:
receiving an assignment from a DCMF; and
switching to the cluster head role based on receiving the assignment.

18. The method of claim 16, further comprising:
performing a handshake operation with the node operating in the cluster head role; and
switching to the cluster head role based on performing the handshake operation.

19. The method of claim 16, further comprising:
performing an autonomous cluster head reselection operation based on a capability ID; and
switching to the cluster head role based on performing the autonomous cluster head reselection operation.

20. The method of claim 19, wherein the capability ID is based on compute resources or ability to act in the cluster head role.
